(19) United States
(12) Patent Application Publication
(10) Pub. No.: US 2006/0104296 A1
(43) Pub. Date: May 18, 2006

(54) Ring network for a burst switching network with distributed management

(75) Inventor: Miguel De Vega Rodrigo, Lambert Brussels (BE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/272,171

(22) Filed: Nov. 10, 2005

(30) Foreign Application Priority Data
Nov. 12, 2004 (EP) 04026929.2

(51) Int. Cl. H04L 12/28

(52) U.S. Cl. 370/403

(57) ABSTRACT

Transmitting data in a ring network that transmits bursts and data packets. A path setup message is sent to request a data transmission between a source node and a destination node j through intermediate nodes connecting the source node and the destination node j. Each intermediate node determines that a connection to a next node along the path is available when the connection to the next node, that normally transmits bursts and data packets, transmits data packets. A current data transmission of data packets on the path is stopped when the entire path is determined to be available.

### CROSS REFERENCE TO RELATED APPLICATIONS

This application claims priority of European application No. 04026929.2 EP filed Nov. 12, 2004, which is incorporated by reference herein in its entirety.

### FIELD OF INVENTION

The present invention relates to transmitting data in a ring in a network as a combination of reserved bandwidth bursts and IP packets that are sent on-the-fly and, more particularly, to an Adaptive Burst Switching Optical Network (APSON) APSON.

APSON may be thought of as a hybrid network technology between Optical Burst Switching (OBS) and ASON (Automatic Switched Optical Networks). This will be appreciated from FIG. 1 which shows the three transport networks 100 side-by-side.

In OBS networks 102, the bandwidth 104 associated to this path is reserved as long as the path is not torn down, which basically means that these bandwidth resources are not available to other sources. In other words, the transmitted data is protected as long as the path exists.

It is important to note, however, that in OBS networks, only the bandwidth equivalent to the duration of the burst is reserved. If another burst wishes to be transferred before this protected data time gap is over, i.e., before the current burst has been transmitted, it will be blocked. In addition, in OBS networks no information can be sent between bursts as shown by the wasted bandwidth section 106.

In ASON (108, FIG. 1), data is sent as it arrives, i.e., “on-the-fly” through an established path. The data is normally IP packets 110 and the bandwidth is not reserved. Naturally, this means that ASON is more flexible than OBS, which makes it easier to implement Quality of Service (QoS) rules for treating different customers differently. On the other hand, ASON is not structured and is more difficult to control than OBS.

In APSON 112, the duration of the reserved bandwidth 114, i.e., the duration of the protected data, is detached from the duration of a burst transmission 1 16. In other words, the APSON scheme is both a λ-switching regime and an unprotected data time gap, wherein the bursts are transmitted under a protected transmission while the IP packets that are sent on-the-fly are transmitted, either protected or unprotected, in the λ-switching. This allows for more flexibility when implementing different quality of service (QoS) to different customers based on, for example, customer plans.

### SUMMARY OF THE INVENTION

There are similarities between APSON and these previous networks, however, APSON is really a unique network scheme. Prior to the creation of a new lightpath, for example, packets are collected in an aggregation buffer. This is somewhat similar to OBS networks. Some other concepts were borrowed from OBS networks as well, such as the OBS bandwidth reservation scheme. However, APSON is distinctly different than OBS. Most significantly, APSON effectuates a circuit switching philosophy similar to ASON, whilst OBS networks use a packet switching approach. Thus, APSON, while a hybrid of the two network philosophies, is a completely different type of network.

Because APSON is a brand new switching scheme, it has not yet been discussed in the field how to provide a ring topology for APSON. However, it would be advantageous to provide a ring topology to APSON because rings are simple to implement and, for this reason, have historically played an important role in optical networks. For instance, routing, switching and network management tasks are considerably less complex in ring topologies in comparison to meshed topologies. For this reason, rings would be a highly desirable topology for deploying new optical network technologies such as APSON.

The invention aims at providing the basic concepts for the deployment of a simple, yet, highly efficient centralized APSON. In providing a viable centralized approach, special consideration is given to the current technological limitations at the optical layer, such, for example, the switching speed.

Ring topologies have been widely studied in λ-switching networks. More recently, OBS ring networks have re-awakened the interest of the research community and this has resulted in many more-recent studies investigating the performance of rings in light of λ-switching networks. Studies, such as A. Zapata, I. de Miguel, M. Düser, J. Spencer, P. Bayvel, D. Breuer, N. Hanik, and A. Gladisch. Performance comparison of static and dynamic optical metro ring network architectures. Proceedings ECOC 2003, have suggested that the most promising architecture in terms of delay, network throughput and the number of wavelengths needed is not OBS but, rather, a variant of OBS called Wavelength Routed OBS networks (WR-OBS). Apparently, the difference is that the source in OBS networks sends a header packet and, after waiting an offset time, sends the burst as well. In WR-OBS networks, by contrast, the source sends a header packet but it waits for an acknowledgement from the network before sending the burst.

The fact that “Zapata” and similar studies point out that WR-OBS networks are the most promising architecture for optical ring networks is hopeful news for APSON. APSON uses a similar acknowledgement-based variant of OBS signalling in order to setup a lightpath. However, it is not yet known for certain whether a ring topology would be as advantageous for APSON. Nor is it certain or defined how a ring topology would be applied for APSON.

To date, there has been no concept for a distributed APSON ring defined. However, encouraging studies such as Zapata's is motivating. It would, therefore, be advantageous to find a viable and efficient APSON-based ring solution. Such a solution should, in theory, have even better results than in the ring WR-OBS architecture since APSON has advantages in comparison to OBS-based solutions like WR-OBS networks.

For one thing, an APSON ring topology would be able to reuse the standardized ASON control plane. Moreover, an APSON ring would be easier and quicker to deploy due to fewer technological challenges. An APSON ring would also offer less delay, higher throughput, lower signalling overhead and self-organizing architecture.

APSON-based rings present advantages also in comparison to λ-switching approaches. In a pure all-optical λ-switching rings with N nodes, each node requires a channel in order to receive data from the rest of the nodes. Therefore, a total of M=N−1 channels are needed. Due to the fact that APSON presents time multiplexing of bandwidth resources, the number of wavelengths needed will be reduced compared to the λ-switching case.

To explain, if multimode fibers are being used, a channel would represent a wavelength in one of the fibers. But, it must be remembered that a channel is a concept at the logical layer. If monomode fibers are being used, a channel would directly represent one of the fibers. At any rate, the mapping between channels and wavelengths (between logical and physical layer) can be easily achieved according to the type of optical fiber being used (mono- vs. multimode) and whether λ-conversion capabilities are available. With λ-conversion capabilities the number of wavelengths W needed is W=M. In our discussion λ-conversion is not available so the number of wavelengths needed is W=M+1=N, be it in a mono- or multimode fiber.

In APSON, the multiplexing clearly reduces the number of wavelengths needed dramatically. Moreover, there is always a number of optical components associated with each wavelength. Some of these optical components, such as tunable lasers, are quite expensive. Therefore, the reduction in the number of wavelengths needed has a great impact on cost, which is a main motivation for the invention to propose and research the effectiveness of APSON rings. Heretofore, there has been no application of a ring topology to APSON.

However, the motivation to develop an APSON ring topology belies the following problem. Presently, commercially available switching fabrics offer switching speeds usually in the order of milliseconds. This leads to path setup times in the order of seconds, sometimes longer, which is clearly not fast enough for a truly dynamic switching architecture with link capacities in the order of Gbps. With the current switching speeds, every time a new path setup takes place, a non-negligible amount of bandwidth is wasted. This increases the blocking probability, which leads to the need of a higher number of wavelengths and their associated expensive optical hardware, such as tunable lasers. Therefore, the slower the switching fabric and the higher the number of path setups per unit of time the higher the costs in optical hardware. This presents at least one major obstacle to be overcome in order to implement dynamic switching architectures such as ASON, APSON or, for that matter, OBS.

In order to reduce hardware costs either faster low-cost switching fabric should be produced or an optical solution that reduces the number of switching actions per unit of time should be used. The first possibility is at present an unlikely solution given the limitations in current technology. The invention focuses on the second alternative to provide a viable ring topology solution for APSON.

The present invention provides a feasible centralized APSON ring with present-day optical components without sacrificing high network performance.

The concept is to design a distributed APSON ring that is feasible with present day optical components without renouncing to high network performance.

It shall be appreciated that the use of APSON in the present invention reduces to zero, or substantially zero, or otherwise reducing, the number of switching actions per unit of time inside the ring network.

A method for transmitting data in a ring network that transmits bursts and data packets, characterized in that, sending a path setup message (306), to request a data transmission between a source node (302ᵢ) and a destination node j (302ⱼ) through intermediate nodes (302_{N}) connecting the source node (302ᵢ) and the destination node j 302ⱼ, determining by each intermediate node that a connection to a next node along the path is available when the connection to the next node, that normally transmits bursts and data packets, transmits data packets, and stopping a current data transmission of data packets on the path when the entire path is determined to be available.

A distributed ring network that transmits bursts and data packets, characterized in that, N nodes (302_{1-N}) including a source node (302ᵢ) that requests a data transmission to be set up to a destination node j (302ⱼ) through intermediate nodes (302_{N}), M channels (304) coupling the N nodes (302_{1-N}), one or more channels (304) comprising a path for transmitting the data transmission between the source node (302ᵢ) and the destination node j (302ⱼ), wherein, the destination node (302ⱼ) determines that the path is available when each of the intermediate nodes on the path, that normally transmits bursts and data packets, transmits data packets.

In one aspect, and in order to reduce costs and to make the concept feasible with the optical technologies of today, no λ-conversion capabilities inside the ring network will be used.

In another aspect, and in order to reduce costs and to make the concept feasible with the optical technologies of today, no dynamic switching inside the ring network will be used.

### BRIEF DESCRIPTION OF THE DRAWINGS

The drawings illustrate at least one example of the invention, wherein:

FIG. 1 shows various transport schemes;

FIG. 2 shows a schematic diagram of the present invention; and

FIG. 3 shows the present invention in terms of functional description.

### DETAILED DESCRIPTION OF THE PREFERRED EMBODIMENTS

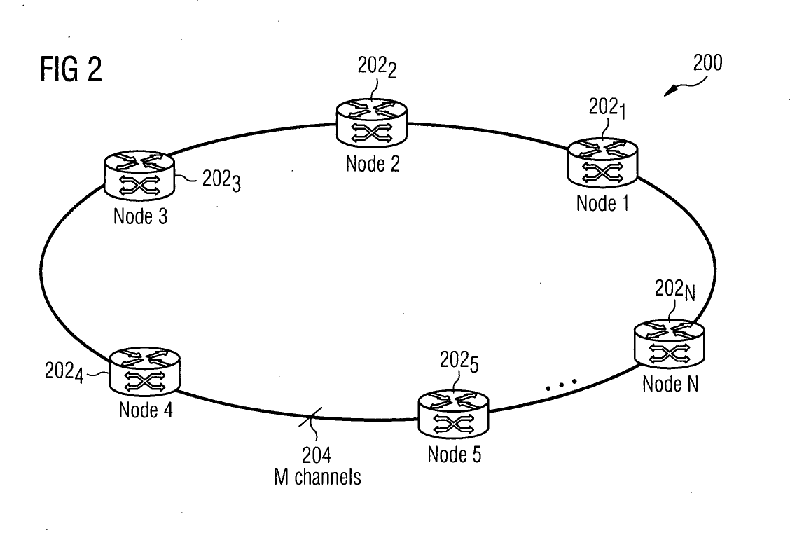

A distributed ring architecture 200 will now be discussed with reference to FIG. 2. In the figure, there is shown N nodes 202_{1-N} and M channels 204. As opposed to a centralized network, where a core or control node controls data flow, the distributed network of FIG. 2 provides distributed or shared network control amongst the various nodes 202_{1-N}.

In a centralized network, in order to schedule message flows the core node generates a path setup message indicating in a special field the length for which bandwidth will be reserved. The network or the central control node guarantees that if a positive acknowledgement to the path setup message is granted, no other node can interrupt the data transmission during this reserved time. Data transferred during the time for which bandwidth has been reserved is called protected data. Data transferred after the protected data has been sent is called unprotected data. No bandwidth has been reserved for unprotected data and therefore other sources can interrupt its transmission. A data flow comprises the transmission of the protected data plus possibly the transmission of unprotected data.

In the present invention, there is provided a distributed ring architecture 200 with N nodes 202_{1-N} in M channels 204. There are no core nodes. The present invention applies particularly to a type of network that transmits both bursts, i.e., data packets during reserved bandwidth, and data packets on-the-fly. In particular, the present invention pertains to the already-described APSON.

In summary, when a transmission is desired to be made between a source node i 202ᵢ and a destination node j 202ⱼ, for example, a path setup message is forwarded by each of the intermediate nodes along the selected path. In each instance, the intermediate node receiving the message determines whether the channel along the path that is to transmit data from the source node i 202ᵢ to the destination node j 202ⱼ is available to that particular intermediate node. Unlike in a centralized network, it is the intermediate nodes that have access to the information of the connectivity of the channels coupled to them and it is the intermediate nodes that determine and decide that the path is available, i.e., unprotected.

In the case that the channel coupled to the intermediate node is available, the intermediate node, in this example, modifies the path setup message to indicate that the channel coupled to that intermediate is available and forwards the path setup message to the next intermediary node in the path. This process continues until the destination node j 202ⱼ receives the path setup message.

It should be noted that, in this embodiment, only the destination node j 202ⱼ knows that the selected path is available. It is the destination node j 202ⱼ, that receives the path setup message from the last intermediate node. At this time, the destination node j 202ⱼ then proceeds to set up the channel. Another way to describe the situation is that the path is not set up until the destination node j 202ⱼ receives the path setup message, because it is not until the last intermediary node forwards the path setup message to the destination node j 202ⱼ that the channel is available.

Since APSON provides time multiplexing of the wavelength capacities normally, the number of channels will be below the number of nodes (M≦N) in the present invention. This is a major advantage in comparison to λ-switching networks. Without λ-conversion an APSON data flow (composed by a burst plus possibly IP packets) uses the same wavelength along its path. Thus, minimizing the number of channels needed.

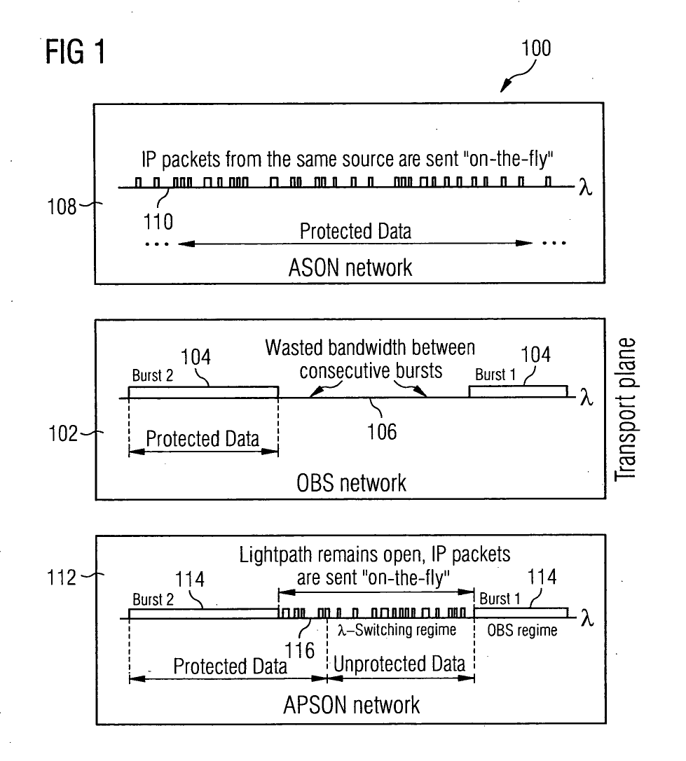

It should be pointed out that, without dynamic switching, an APSON data flow uses the same fixed combination of fibers along its path. This means at the logical layer (see FIG. 1) that the APSON data flow once in channel x does not switch to another channel y (with x≠y). If multimode fibers are being used, a channel represents a wavelength in one of these fibers. If monomode fibers are being used, a channel directly represents one of these fibers.

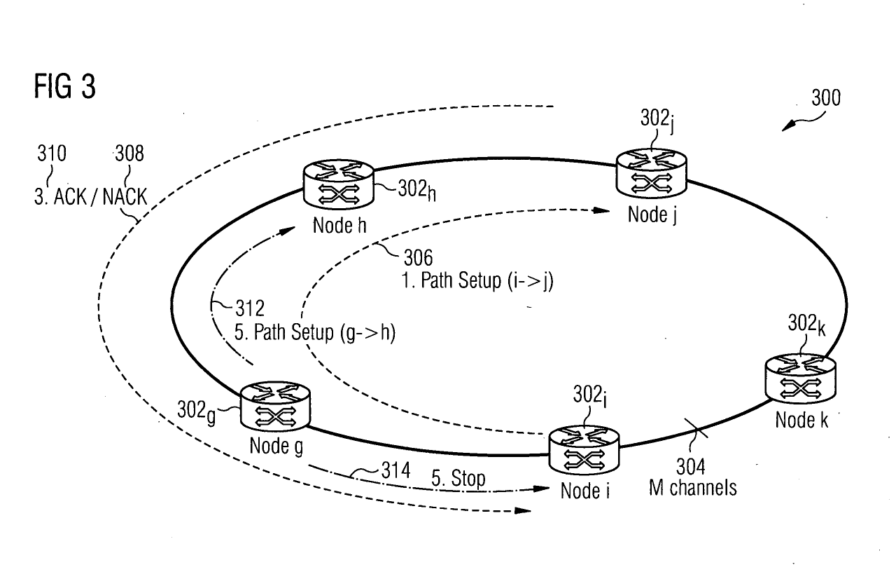

In order to better understand the distributed APSON according to the present invention, the functional description of the distributed ring APSON shall be described with reference to the distributed ring architecture 300 shown in FIG. 3. As in the previous figure, N nodes (here, 302ₕ₋ₖ) are coupled to each other through M channels 304.

In order for node i 302ᵢ to send a data flow to node j 302ⱼ, the following steps are carried out. Preferably, the steps are carried out in the order set forth, but may be arranged in another order.

In normal switching operation, each node 302_{g-k} receives incoming IP packets, sorts them according to their destination and collects them in different buffers, each one for each destination. In order to set up a connection, node i 302ᵢ sends a path setup message 306 to destination node j 302ⱼ. This may be done whenever a predetermined algorithm, such as an “aggregation strategy”, decides that enough packets for destination j 302ⱼ have been collected in the correspondent buffer.

The path setup message 306, in the preferred embodiment, includes a Source field, a Destination field, a Duration field and a Channel field. The Duration field indicates the duration of the protected data for which bandwidth will be reserved. The Channel field indicates the channel on which the source wishes to send the data flow. The Source and Destination fields designate the source and destination nodes.

In a second step, each intermediate node along the path from source i 302ᵢ to destination j 302ⱼ reads the path setup message 306 and checks for the availability of the channel specified in the Channel field. If the channel is not available, the intermediate node sends a NACK (not acknowledge) message 308 back to the source node i 302ᵢ indicating that the data flow cannot be accommodated.

The intermediate node copies, in a special field of the NACK message 308 called the channel field, the number of the channel specified in the channel field of the path setup message 306. Each intermediate node receiving a NACK message 308 changes the status of the channel specified in the channel field to unavailable.

Otherwise the intermediate node forwards the path setup message 306 to the next node along the path of the data flow and changes the status of the channel specified in the channel field of the path setup message 306 to available.

In a third step, if all of the intermediate nodes can accommodate the data flow from source i 302ᵢ, the path setup message 306 eventually arrives at the destination node. In this case, the destination node 302ⱼ sends an ACK (acknowledge) message 210 back to the source node i 302ᵢ indicating that the data flow can be transferred.

In a fourth step, when the source node i 302ᵢ receives a NACK message 308 it may perform one of the following operations according to the particular implementation of the decentralized APSON ring architecture. First, it may discard the data flow. For example, all of the packets may be discarded in the edge node buffer. Second, a data flow transmission may be reattempted after a certain time tₐₜₜₑₘₚ on a certain channel λ. This time may be zero, constant, random or chosen according to a certain algorithm. The channel λ may be the same as before or a different one chosen according to a certain algorithm. When the source node i 302ᵢ receives an ACK message 210, it transfers the data flow.

In a fifth step, when another source wishes to send a data flow on the same channel through partially or totally the same end-to-end path as the ongoing data flow transmission from i 302ᵢ to j 302ⱼ, it sends a new path setup message to the destination node.

In the situation that an ongoing data flow is currently sending data packets on-the-fly, in other words, as unprotected data, the channel is determined to be available and the ongoing data flow is interrupted.

Two cases should be distinguished in this case. The first is when the new source k 302ₖ sends the new data flow through the source i 302ᵢ of the ongoing data flow, as in FIG. 2. The second is when the source of the ongoing data flow i 302ᵢ sends the old data flow through the source of the new data flow g 212.

In the first case, node i 302ᵢ automatically stops sending the ongoing data flow when it receives the path setup from node k 302ₖ. In the second case, node g 302_{g} sends a stop message 214 back to the source of the ongoing data flow (node i). When node i 302ᵢ receives a stop message 214 it automatically stops sending the ongoing data flow. In the case that the ongoing data flow is currently sending protected data, the channel is determined to be unavailable and the ongoing data flow is not interrupted.

In another version of the invention, the invention implements λ-conversion-capable optical components. In this case, the path setup message is not provided with a Channel field. Instead, each intermediate node checks if there is any available channel. This may be accomplished by providing a new parameter, L_{available} that is designated the list of available channels for the transmission of the data flow in the intermediate node. If L_{available} has more than one element, the intermediate node(s) selects one of the channels according to a certain criteria. The selected channel is declared as unavailable and the path setup message is forwarded. The remainder of the procedure is similar to the previously-described case.

In another variant of the invention, the path setup message includes an extra field called the Channel Pool field. The source node provides this field with the list of all possible channels through which it could send the data flow. Each intermediate node eliminates from this list the channels that are not available. However it declares as unavailable only the channel specified in the channel field of the path setup message similar to the above case.

In this version each intermediate node forwards the path setup message even if the channel specified in the channel field is not available. In this case the intermediate node changes the value of the channel field to, for instance, −1, in order to inform the destination node that some intermediate nodes cannot accommodate the data flow in the specified channel. If the destination node receives a path setup message with the channel field intact, then it returns an ACK to the source signalling that it might begin the flow transmission.

On the other hand, if the channel field contains a value, such as −1, the destination node checks the channel pool field. If this field is not empty, then the destination node selects one channel from it according to a certain criteria and returns a NACK message to the source with an additional field, herein referred to as the Proposed Channel, containing the selected channel. Each intermediate node receiving a NACK message declares as available the channel specified in the channel field of the NACK message just as before. The source node receives the NACK message, reads the proposed channel field and returns another path setup with the proposed channel in the channel field with the hope that the proposed channel is still available. In this manner, the solution is more efficient since a NACK message might contain as well information regarding a channel which was at least available by the time the NACK message was created.

The Distributed APSON Ring concept of the present invention is advantageous. For one thing, the solution is valid for both uni- and bidirectional links. Due to the efficient wavelength time multiplexing of APSON, the number of wavelengths for a given ring topology and given offered traffic volume is reduced in comparison to WR-OBS, OBS and especially to λ-switching networks. Since each wavelength has associated several optical components, some of which are quite expensive such as the tuneable lasers, the number of wavelengths is reduced. This results in important cost savings on optical components that are no longer needed.

Again, due to the fact that APSON presents the most efficient wavelength time multiplexing in comparison to WR-OBS, OBS architectures, the inventive distributed APSON rings offer a lower delay, delay jitter that their OBS-based counterparts. For the same reason, the blocking probability in distributed APSON rings is virtually zero. The concept allows for QoS implementations, as well as an all-optical transport plane. The concept allows to implement more complex and efficient or less complex and efficient solutions depending on the needs.

With the present invention, switching can be eliminated. As a consequence of this the switching speed of the switching fabric does not play an important role anymore, which allows for a direct cost reduction. The invention, thus, does not require λ-conversion although it is valid for a case with λ-conversion. Further, a distributed APSON ring architecture presents no single point of failure (no centralized control node) unlike a centralized APSON ring approach. In addition, the present invention presents no scalability problems due to the increasing workload in a centralized control node as network increases its size unlike in a centralized APSON ring approach.

1-14. (canceled)

15. A method for transmitting data in a ring network that transmits burst and data packets, comprising:
sending a path setup message to request a data transmission between a source node and a destination node through an intermediate node, the intermediate node connecting the source node and the destination mode;
determining by the intermediate node that a connection to a next node along a path is available when the connection to the next node, which normally transmits burst and data packets, transmits data packets; and
stopping a current data transmission of data packets on the path when the entire path is determined to be available.

16. The method according to claim 15, further comprising determining that the path is available when the data transmission on the path is unprotected.

17. The method according to claim 15, further comprising sending a negative acknowledgement message (NACK) indicating that the data transmission cannot be accommodated, sending the negative acknowledgement message (NACK) by the intermediate node to the source node when the path is not available.

18. The method according to claim 17, further comprising receiving by the source node the negative acknowledgement message (NACK) and discarding the data flow.

19. The method according to claim 15, further comprising sending an acknowledge message (ACK) indicating that the data flow can be transferred on a path, sending the acknowledge message (ACK) by the destination node to the source node.

20. The method according to claim 18, further comprising reattempting the data transmission on a channel after a time.

21. The method according to claim 19, further comprising reattempting the data transmission on a channel after a time.

22. The method according to claim 19, further comprising sending a new path setup message to the destination node when a second source node is sending a data transmission through at least partially the same path.

23. The method according to claim 19, further comprising including a channel pool filed in the setup message by the source node, the channel pool field is a list of possible channels that the source node sends the data transmission.

24. The method according to claim 15, wherein the next node is the intermediate node or the destination node.

25. A distributed ring network that transmits burst and data packets, comprising:
a plurality of nodes including a source node, an intermediate node, and a destination node, the source node requests a data transmission to be set up to the destination node via the intermediate node;
a path for transmitting the data transmission between the source node and the destination node; and
at least one channel, each channel coupling two nodes from the plurality of nodes, at least one channel comprising the path,
wherein the destination node determines that the path is available when the intermediate node on the path, which normally transmits burst and data packets, is transmitting data packets.

26. The distributed ring network according to claim 25, wherein the source node sends a path setup message, which indicates a path to set up a data transmission, to the destination node.

27. The distributed ring network according to claim 0, wherein the intermediate node on the path between the source node and the destination node reads the path from the path setup message.

28. The distributed ring network according to claim 27, wherein the intermediate node on the path between the source node determines an availability of a channel connected to a respective intermediate node and a next node on the path specified in the path setup message.

29. The distributed ring network according to claim 28, wherein the distributed ring network implements a λ-conversion-capable optical components.
